(19) United States
(12) Patent Application Publication
(10) Pub. No.: US 2013/0247715 A1
(43) Pub. Date: Sep. 26, 2013

(54) CRANKSHAFT FOR AN INTERNAL COMBUSTION ENGINE

(71) Applicants: Alan W. Hayman, Romeo, MI (US); James J. Mazzola, III, Dryden, MI (US)

(72) Inventors: Alan W. Hayman, Romeo, MI (US); James J. Mazzola, III, Dryden, MI (US)

(73) Assignee: GM GLOBAL TECHNOLOGY OPERATIONS LLC, Detroit, MI (US)

(21) Appl. No.: 13/428,618

(22) Filed: Mar. 23, 2012

(51) Int. Cl. F16C 3/06

(52) U.S. Cl. 74/596

(57) ABSTRACT

A crankshaft for an internal combustion engine comprises at least four main journals aligned on a crankshaft axis of rotation and at least six crankpins, each being disposed about a respective crankpin axis and positioned between the at least four main journals. Each of the respective crankpin axes is oriented parallel to, and spaced radially from, the crankshaft axis of rotation. Each of the at least six crankpins is joined to a pair of crank arms for force transmission between each of the at least six crankpins and the respective pair of crank arms. Each crank arm is joined to a respective main journal for transmitting torque between the crank arm and the main journal. The at least six crankpins are disposed asymmetrically about the crankshaft axis of rotation.

### FIELD OF THE INVENTION

Exemplary embodiments of the invention relate to crankshafts for internal combustion engines and, more particularly, to a crankshaft for an internal combustion engine having a grouping of six crankpins, in which the crankpins are disposed asymmetrically about the crankshaft axis of rotation.

### BACKGROUND

With the increased focus on vehicle emissions, exhaust gas recirculation (“EGR”) is utilized in many conventional internal combustion engines to assist in the reduction of throttling losses at low loads, to improve knock tolerance, and to reduce the level of oxides of nitrogen (“NOₓ”) in the exhaust gas at high engine loads. EGR is especially important as an emissions reducer in internal combustion engines that run lean of stoichiometry and thereby are prone to emitting higher levels of NOₓ emissions.

One proposition that has been considered in the construction of internal combustion engine systems is to utilize one or more of a plurality of cylinders as a dedicated source of EGR. For example, in an engine having two or more cylinders, the entire supply of exhaust gas produced in one of the cylinders is transferred to the intake ports of the other cylinders as EGR. In engines having greater numbers of cylinders (e.g., 4, 6, or 8 cylinders), timing considerations may cause it to be advantageous to dedicate up to half of the cylinders (i.e., 2, 3, or 4 cylinders) to the production of EGR.

A disadvantage to this type of internal combustion engine system is that an internal combustion engine that dedicates the use of one or more cylinders to production of EGR may not deliver EGR uniformly to the remaining cylinders. For example, the cylinder event following the dedicated EGR cylinder event may be prone to receive more EGR diluent than the subsequently firing cylinders. These variations in cylinder makeup (i.e. combustion air, fuel and EGR diluent) can result in uneven combustion performance that is difficult to control over a broad range of operating conditions. In addition, engines having displacements that are uniform among the cylinders, may be incapable of precisely delivering desired quantities of EGR.

To at least partially address these disadvantages, a number of configurations are being studied, including configurations wherein more than one in four cylinders operates as a dedicated EGR cylinder or where a dedicated EGR cylinder produces more than a single volume of exhaust gas for every four volumes of exhaust gas produced by other cylinders. To enable such configurations, it would be advantageous to have a crankshaft that can facilitate improved distribution of EGR among non-EGR cylinders.

### SUMMARY

In an exemplary embodiment, a crankshaft for an internal combustion engine comprises at least four main journals aligned on a crankshaft axis of rotation and at least six crankpins, each being disposed about a respective crankpin axis and positioned between the at least four main journals. Each of the respective crankpin axes is oriented parallel to, and spaced radially from, the crankshaft axis of rotation. Each of the at least six crankpins is joined to a pair of crank arms for force transmission between each of the at least six crankpins and the respective pair of crank arms. Each crank arm is joined to a respective main journal for transmitting torque between the crank arm and the main journal. The at least six crankpins are disposed asymmetrically about the crankshaft axis of rotation.

The above features and advantages, and other features and advantages of the invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a schematic plan view of portions of an internal combustion engine system embodying features of the invention;

FIG. 2 is a schematic end view of portions of an internal combustion engine system embodying features of another embodiment of the invention;

FIG. 3 is a schematic side view of portions of a crankshaft of an internal combustion engine system embodying features of another embodiment of the invention;

FIG. 4 is a schematic end view of portions of a crankshaft of an internal combustion engine system embodying features of another embodiment of the invention;

FIG. 5 is a schematic end view of portions of a crankshaft of an internal combustion engine system embodying features of another embodiment of the invention;

FIG. 6 is a schematic end view of portions of a crankshaft of an internal combustion engine system embodying features of another embodiment of the invention; and

FIG. 7 is a schematic end view of portions of a crankshaft of an internal combustion engine system embodying features of another embodiment of the invention.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

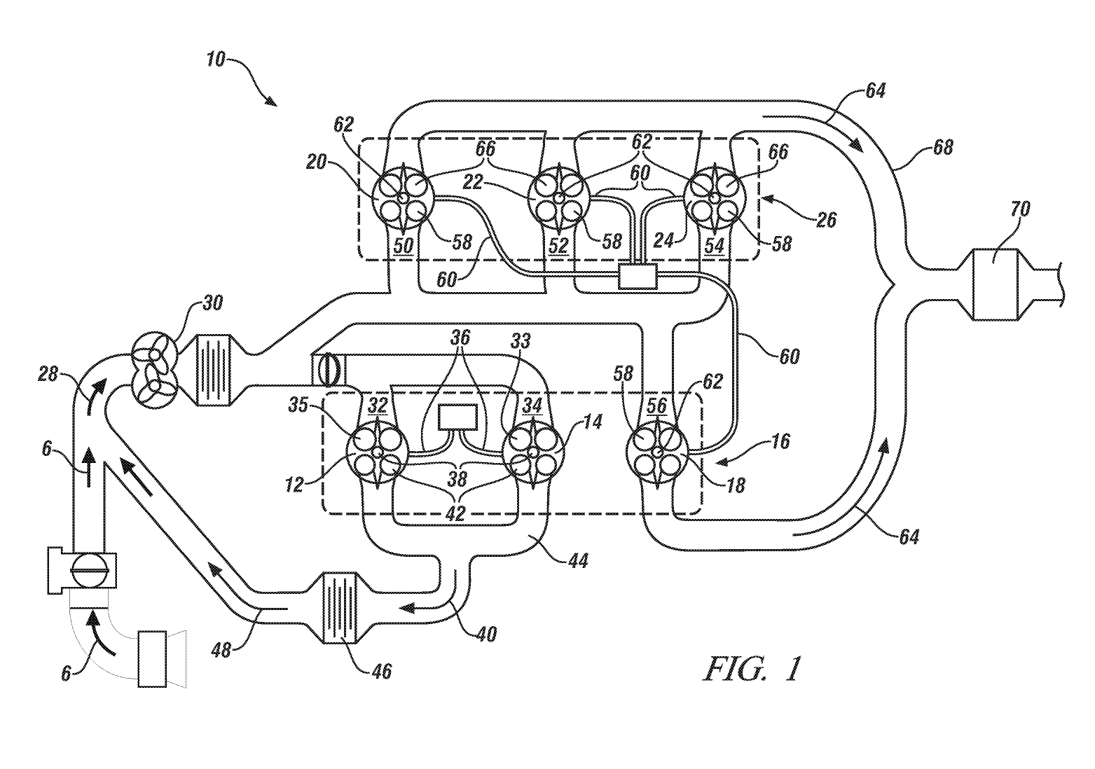

Referring now to FIG. 1 and FIG. 2, an exemplary embodiment of the invention is directed to an internal combustion engine system 10 comprising a pair of dedicated EGR-producing cylinders 12, 14 arranged in a left bank 16. Engine system 10 also comprises an EGR-consuming cylinder 18 that is also arranged in the left bank 16 and three additional EGR-consuming cylinders 20, 22, 24 arranged in a right bank 26. Thus, in the embodiment illustrated, the internal combustion engine system 10 includes two EGR-producing cylinders 12, 14 and four EGR-consuming cylinders 18, 20, 22, 24, however the configuration may also include any combination of number of EGR-producing cylinders and EGR-consuming cylinders (ex. 3, 4, 5, 6, 8, 10, 12, etc.) as well as configurations such as V-configured, horizontally opposed and the like, without affecting the application of the invention thereto. In an exemplary embodiment, both the EGR-producing cylinders 12, 14 are configured to operate on a two-stroke combustion cycle, and all four of the EGR-consuming cylinders 18, 20, 22, 24 are configured to operate on a four-stroke combustion cycle. In an exemplary embodiment, both of the EGR-producing cylinders 12, 14 are positioned adjacent to one another in the left bank 16 so as to facilitate a simplified arrangement of passages for carrying the EGR gases from the EGR-producing cylinders 12, 14 to the EGR-consuming cylinders 18, 20, 22, 24.

In an exemplary embodiment, combustion air 28 is compressed by a compressor 30, which may comprise an engine driven supercharger, an exhaust driven turbocharger or a combination of both (i.e. super-turbocharger), before being delivered to each of the EGR-producing cylinders 12, 14 through intake runners 32, 34. The intake runners 32, 34 deliver the compressed combustion air to the EGR-producing cylinders 12, 14 through intake ports 35. The combustion air 28 is mixed with an EGR-producing flow of fuel 36 in the EGR-producing cylinders 12, 14 and is combusted therein. One or more ignition devices such as spark plugs 38 are located in communication with the EGR-producing cylinders 12, 14 and operate to ignite the fuel/air mixture therein at appropriate times.

In an exemplary embodiment, recirculation exhaust gas 40 from the combustion of the EGR-producing flow of fuel 36 and combustion air 28 in the EGR-producing cylinders 12, 14 is removed from each EGR-producing cylinder 12, 14 through one or more exhaust ports 42 in fluid communication with an EGR conduit 44. EGR conduit 44 carries recirculation exhaust gas 40 from exhaust ports 42 and through a heat exchanger 46 to produce a cooled stream of EGR gas 48. The heat exchanger 46 may be of an air cooled or liquid cooled configuration. In an exemplary embodiment, the cooled stream of EGR gas 48 is combined with a stream of fresh air 6 to form the stream of combustion air 28, which is delivered to each of the EGR-consuming cylinders 18, 20, 22, 24 through intake runners 50, 52, 54, 56.

The intake runners 50, 52, 54, 56 deliver the combustion air 28 to the EGR-consuming cylinders 18, 20, 22, 24 through intake ports 58. The combustion air 28 is mixed with an EGR-consuming flow of fuel 60 in the EGR-consuming cylinders 18, 20, 22, 24 and is combusted therein. One or more ignition devices such as spark plugs 62 are located in communication with the EGR-consuming cylinders 18, 20, 22, 24 and operate to ignite the fuel/air mixture therein at appropriate times.

In an exemplary embodiment, discharge exhaust gas 64 from the combustion of the EGR-consuming flow of fuel 60 and combustion air 28 in the EGR-consuming cylinders 18, 20, 22, 24 is removed from each EGR-consuming cylinder 18, 20, 22, 24 through one or more exhaust ports 66 in fluid communication with a discharge exhaust system 68. Discharge exhaust system 68 carries discharge exhaust gas 64 from exhaust ports 66 and through an exhaust treatment system 70 prior to being released to the atmosphere. The exhaust treatment system 70 may include various exhaust gas treatment devices such as a catalytic converter, a selective catalytic reduction device, a particulate trap or a combination thereof.

In an exemplary embodiment, the quantity of fuel mixed with the combustion air 28 in each of the EGR-producing cylinders 12, 14 is controlled such that each of the EGR-producing cylinders 12, 14 is operated at a customized level of air and fuel, as may be determined by an engine controller that is in signal communication with various engine, vehicle and exhaust system sensors. Since the exhaust gas discharged from the EGR-producing cylinders 12, 14 is to be ingested in one of the EGR-consuming cylinders 18, 20, 22, 24 before being released to the atmosphere, the customized air and fuel levels in each of the EGR-producing cylinders 12, 14 may be optimized to achieve selected goals such as engine efficiency, power, and operability. Accordingly, the EGR-producing cylinders are at least partially freed from encumbrances related to regulated constituents in gases they discharge.

Since exhaust gas produced by the EGR-consuming cylinders 18, 20, 22, 24 is to be released to the atmosphere, either directly or following treatment in an exhaust gas treatment system, the air and fuel mixtures of these EGR-consuming cylinders 18, 20, 22, 24 may be operated so as to meet a number of goals, such as engine efficiency, power, and operability, in addition to emission standards. The EGR-consuming cylinders 18, 20, 22, 24 enjoy benefits associated with ingestion of EGR from the EGR-producing cylinders 12. These benefits include reduced combustion temperatures and associated levels of NOₓ, allowing richer levels of EGR in the remaining cylinders with increased levels of hydrogen, thereby improving knock resistance, fuel consumption and combustion stability, while still allowing stoichiometric gas to be maintained in the exhaust gas treatment system for compatibility with the catalytic treatment devices. Accordingly, the re-ingestion of exhaust gas discharged from the EGR-producing cylinders 12, 14 assists in the reduction of throttling losses at low loads and improves knock tolerance while reducing levels of oxides of nitrogen (“NOₓ”) in the discharge exhaust gas 64.

In an exemplary embodiment, the EGR-producing cylinders 12, 14 and the EGR-consuming cylinders 18, 20, 22, 24 interact with a rotating group that comprises pistons (not shown) that are each associated with a respective cylinder and connected through a respective connecting rod (not shown) to a respective crankpin, the crankpins being disposed on a single crankshaft. In an exemplary embodiment, a central axis defined by each EGR-producing cylinder 12, 14 and the EGR-consuming cylinder 18 arranged in left bank 16 is parallel to, and coplanar with, each other central axis defined by those three cylinders 12, 14, 18 arranged in left bank 16. Thus, the central axes of the cylinders 12, 14, 16 of the left bank define a left bank plane 15. In an exemplary embodiment, a central axis defined by each of the EGR-consuming cylinders 20, 22, 24 arranged in right bank 26 is parallel to, and coplanar with, each other central axis defined by each other cylinder 16 arranged in right bank 26. Thus, the central axes of the EGR-consuming cylinders 20, 22, 24 define a right bank plane 19. In a V-configured embodiment, the left bank plane 15 and the right bank plane 19 intersect approximately at a crankshaft axis of rotation and form an engine block angle 21 between the left bank plane 15 and the right bank plane 19. In an exemplary embodiment, the engine block angle 21 is approximately 90 degrees. In another exemplary embodiment, the engine block angle 21 is approximately 60 degrees.

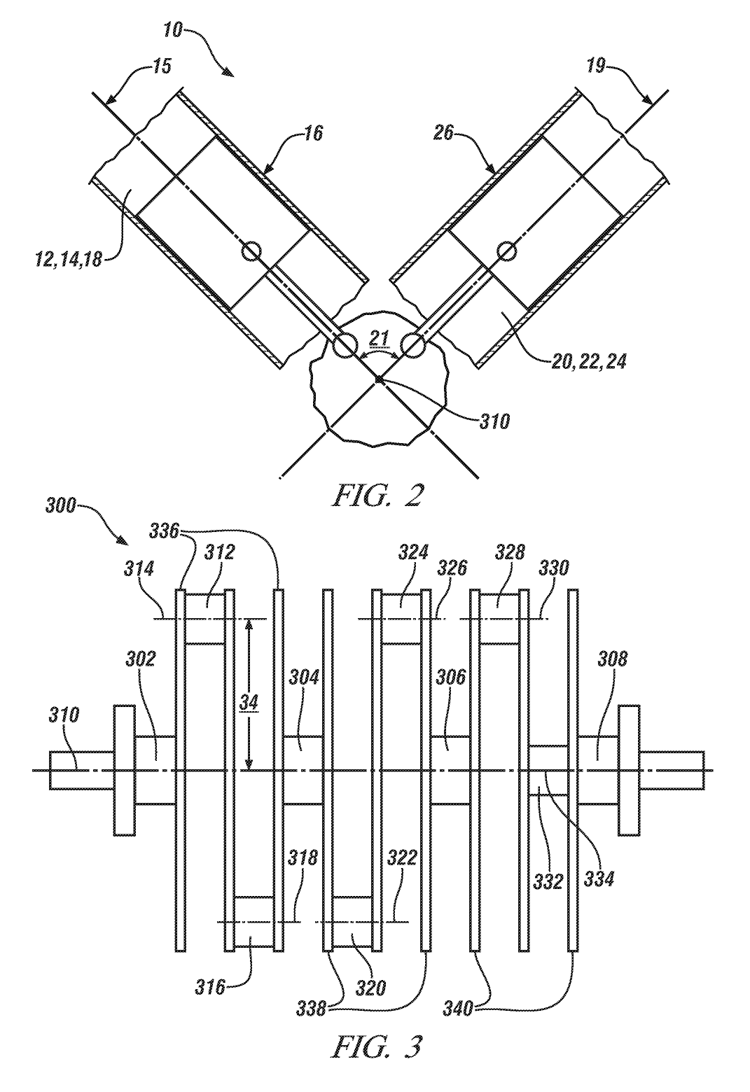

In an exemplary embodiment, as shown in FIG. 3, a crankshaft 300 for an internal combustion engine comprises a plurality of main journals 302, 304, 306, 308 aligned sequentially on a crankshaft axis of rotation 310. A first crankpin 312 is disposed about a first crankpin axis 314 and positioned between the first main journal 302 and the second main journal 304. A second crankpin 316 is disposed about a second crankpin axis 318 and is also positioned between the first main journal 302 and the second main journal 304. A third crankpin 320 is disposed about a third crankpin axis 322 and positioned between the second main journal 304 and the third main journal 306. A fourth crankpin 324 is disposed about a fourth crankpin axis 326 and is also positioned between the second main journal 304 and the third main journal 306. A fifth crankpin 328 is disposed about a fifth crankpin axis 330 and positioned between the third main journal 306 and the fourth main journal 308. A sixth crankpin 332 is disposed about a sixth crankpin axis 334 and is also positioned between the third main journal 306 and the fourth main journal 308. Thus, each of the six crankpins 312, 316, 320, 324, 328, 332 is disposed about a respective crankpin axis 314, 318, 322, 326, 330, 334 and positioned between two of the four main journals 302, 304, 306, 308. In an exemplary embodiment, each crankpin axis 314, 318, 322, 326, 330, 334 is spaced radially a semi-stroke distance 34 from the crankshaft axis of rotation 310.

A first plurality of crank arms 336 is joined to first crankpin 312 and second crankpin 316 for force transmission among first crankpin 312, second crankpin 316, and the first plurality of crank arms 336. In an exemplary embodiment, each of the crank arms 336 is also joined to a respective main journal 302, 304 for transmitting torque among the first plurality of crank arms 336 and the main journals 302, 304. A second plurality of crank arms 338 is joined to third crankpin 320 and fourth crankpin 324 for force transmission among third crankpin 320, fourth crankpin 324, and the second plurality of crank arms 338. In an exemplary embodiment, each of the crank arms 338 is also joined to a respective main journal 304, 306 for transmitting torque among the second plurality of crank arms 338 and the main journals 304, 306. A third plurality of crank arms 340 is joined to fifth crankpin 328 and sixth crankpin 332 for force transmission among fifth crankpin 328, sixth crankpin 332, and the third plurality of crank arms 340. In an exemplary embodiment, each of the crank arms 340 is also joined to a respective main journal 306, 308 for transmitting torque among the third plurality of crank arms 340 and the main journals 306, 308.

In an exemplary embodiment, the right bank 26 (FIGS. 1 and 2) includes three EGR-consuming cylinders 20, 22, 24. The first crankpin 312 (FIG. 3) is mechanically coupled to a piston (not shown) that interacts with a first EGR-consuming cylinder 20. Similarly, the third crankpin 320 is mechanically coupled to a piston that interacts with a second EGR-consuming cylinder 22, and the fifth crankpin 328 is mechanically coupled to a piston that interacts with a third EGR-consuming cylinder 24. One of the remaining three crankpins 316, 324, 332 is mechanically coupled to a piston that interacts with a fourth EGR-consuming cylinder 18. The remaining two crankpins (either 316 and 324 or 324 and 332) are mechanically coupled to a piston that interacts with first and second EGR-producing cylinders 12, 14.

As discussed above, the EGR-producing cylinders 12, 14 are to be operated differently from the EGR-consuming cylinders 18, 20, 22, 24. For example, the EGR-producing cylinders 12, 14 are to be operated at different ratios of fuel to air than the EGR-consuming cylinders 18, 20, 22, 24. In addition, each of the EGR-producing cylinders 12, 14 is to be operated on a two stroke cycle. Thus, each of the EGR-producing cylinders 12, 14 will undergo two combustion events for each single combustion event associated with the EGR-consuming cylinders 18, 20, 22, 24. As a result, there will be equivalent numbers of combustion events among the EGR-producing cylinders 12, 14 and the EGR-consuming cylinders 18, 20, 22, 24. In order to provide adequate quantities of EGR gas 48 to the EGR-consuming cylinders 18, 20, 22, 24, it is desirable to schedule the combustion events among the cylinders such that each combustion event of an EGR-consuming cylinder is immediately preceded by a combustion event in an EGR-producing cylinder 12, 14.

In addition, it is desirable that the crankpins 312, 316, 320, 324, 328, and 332 be arranged to enable, with respect to their associated cylinders, a “near-even fire” combustion sequence. Thus, in an exemplary embodiment with two EGR-producing cylinders 12, 14 and four EGR consuming cylinders 18, 20, 22, 24, eight nearly evenly spaced firing events are produced in about 720 degrees of rotation of the crankshaft. In one embodiment, the firing sequence is such that a firing event occurs at approximately even intervals associated with each 90 degrees of rotation of the crankshaft. According to this fairly precise even-firing embodiment, firing events occur at 0 degrees, 90 degrees, 180 degrees, 270 degrees, 360 degrees, 450 degrees, 540 degrees, 630 degrees, and again at 720 degrees. In another embodiment, firing events associated with one of the EGR-producing cylinders is delayed approximately 30 degrees from the standard interval while firing events associated with the other cylinders occurs on the 90 degree interval. According to this less precise even-firing embodiment, firing events occur at 0 degrees, 120 degrees, 180 degrees, 270 degrees, 360 degrees, 480 degrees, 540 degrees, 630 degrees, and again at 720 degrees.

As discussed above, it is desirable to have EGR-producing cylinders 12, 14 positioned adjacent to one another, and this is facilitated by coupling pistons that interact with the first and second EGR-producing cylinders 12, 14 to either: (1) the second crankpin 316 and the fourth crankpin 324; or (2) the fourth crankpin 324 and the sixth crankpin 332. The first crankpin 312 is coupled to a first EGR-consuming cylinder 20 in the right bank 26. The third crankpin 320 is coupled to a second EGR-consuming cylinder 22 in the right bank 26, and the fifth crankpin 328 is coupled to a third EGR-consuming cylinder 24 in the right bank 26. Either the second crankpin 316 or the sixth crankpin 332 is coupled to the EGR-consuming cylinder 18 in the left bank 16. With respect to each cylinder, a respective crankpin is coupled, through a connecting rod (not shown), to a piston (not shown) that is disposed in either the respective cylinder. Thus, as crankshaft 300 rotates about the crankshaft axis of rotation 310, each crankpin associated with a piston in an EGR-producing cylinder interacts with working fluid (i.e., fuel, air) in the respective EGR-producing cylinder and encounters a combustion event once for every 360 degrees of crankshaft rotation. Similarly, as crankshaft 300 rotates about the crankshaft axis of rotation 310, each crankpin associated with a piston in an EGR-consuming cylinder interacts with working fluid (i.e., fuel, air and EGR mixture) in the respective EGR-consuming cylinder and encounters a combustion event once for every 720 degrees of crankshaft rotation.

Where the second crankpin 316 and the fourth crankpin 324 are coupled to pistons that interact with the first and second EGR-producing cylinders 12, 14, respectively, an exemplary firing order facilitating either a fairly precise even-firing embodiment or a less precise even-firing embodiment includes: (1) a firing event associated with the first EGR-consuming cylinder 20 located in right bank 26 occurring at a crankshaft rotational position of approximately 0 degrees; (2) a firing event associated with the first EGR-producing cylinder 12 occurring at a crankshaft rotational position of approximately 90 or 120 degrees; (3) a firing event associated with the second EGR-consuming cylinder 22 located in right bank 26 occurring at a crankshaft rotational position of approximately 180 degrees; (4) a firing event associated with the second EGR-producing cylinder 14 occurring at a crankshaft rotational position of approximately 270 degrees; (5) a firing event associated with the third EGR-consuming cylinder 24 located in right bank 26 occurring at a crankshaft rotational position of approximately 360 degrees; (6) a firing event associated with the first EGR-producing cylinder 12 occurring at a crankshaft rotational position of approximately 450 or 480 degrees; (7) a firing event associated with the EGR-consuming cylinder 18 located in left bank 16 occurring at a crankshaft rotational position of approximately 540 degrees; and (8) a firing event associated with the second EGR-producing cylinder 14 occurring at a crankshaft rotational position of approximately 630 degrees.

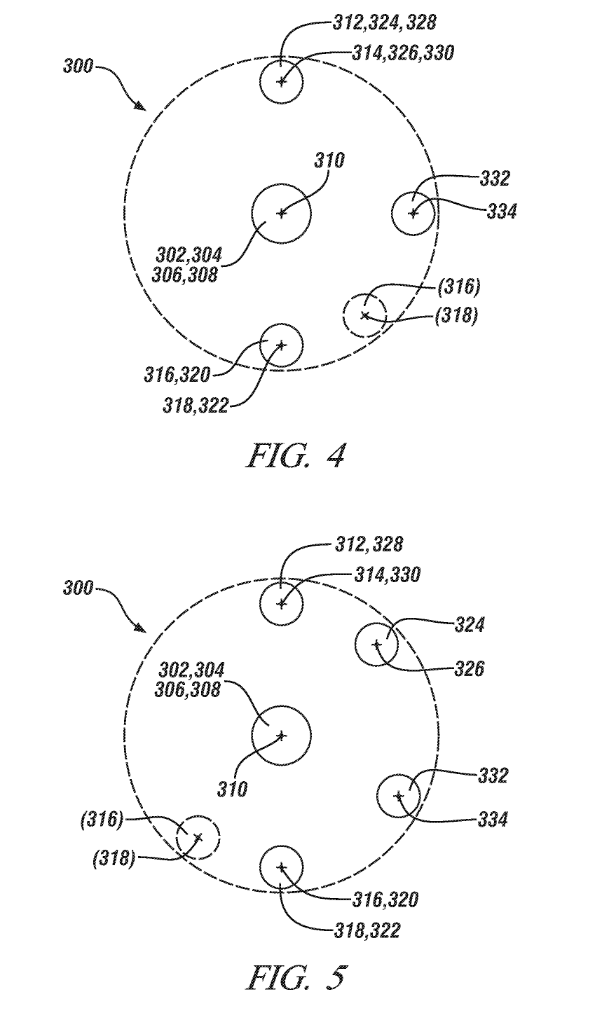

To facilitate such a firing sequence, with an engine block angle 21 of 90 degrees, as shown in FIG. 4, the crankpins 312, 316, 320, 324, 328, and 332 are arranged asymmetrically about the crankshaft axis of rotation as follows: (1) the first crankpin 312 is arranged at a rotational position of approximately 0 degrees; (2) the second crankpin 316 is arranged at a rotational position of approximately 180 degrees (i.e., the second crankpin 316 is disposed approximately 180 degrees from the position of the first crankpin 312) for a fairly precise even-firing embodiment or approximately 210 degrees for a less precise even-firing embodiment; (3) the third crankpin 320 is arranged at a rotational position of approximately 180 degrees; (4) the fourth crankpin 324 is arranged at a rotational position of approximately 0 degrees; (5) the fifth crankpin 328 is arranged at a rotational position of approximately 0 degrees; and (6) the sixth crankpin 332 is arranged at a rotational position of approximately 270 degrees.

To facilitate such a firing sequence, with an engine block angle 21 of 60 degrees, as shown in FIG. 5, the crankpins 316, 324, and 332 interacting with the cylinders of the left bank 16 are shifted 30 degrees about the crankshaft axis of rotation. Accordingly, the crankpins 312, 316, 320, 324, 328, and 332 are arranged asymmetrically about the crankshaft axis of rotation as follows: (1) the first crankpin 312 is arranged at a rotational position of approximately 0 degrees; (2) the second crankpin 316 is arranged at a rotational position of approximately 150 degrees (for a fairly precise even-firing embodiment) or approximately 180 degrees (for a less precise even-firing embodiment); (3) the third crankpin 320 is arranged at a rotational position of approximately 180 degrees; (4) the fourth crankpin 324 is arranged at a rotational position of approximately 330 degrees; (5) the fifth crankpin 328 is arranged at a rotational position of approximately 0 degrees; and (6) the sixth crankpin 332 is arranged at a rotational position of approximately 240 degrees.

Where the fourth crankpin 324 and the sixth crankpin 332 are coupled to pistons that interact with the first and second EGR-producing cylinders 12, 14, respectively, an exemplary firing order facilitating either a fairly precise even-firing embodiment or a less precise even-firing embodiment includes: (1) a firing event associated with the first EGR-consuming cylinder 20 located in right bank 26 occurring at a crankshaft rotational position of approximately 0 degrees; (2) a firing event associated with the second EGR-producing cylinder 14 occurring at a crankshaft rotational position of approximately 90 or 120 degrees; (3) a firing event associated with the third EGR-consuming cylinder 24 located in right bank 26 occurring at a crankshaft rotational position of approximately 180 degrees; (4) a firing event associated with the first EGR-producing cylinder 12 occurring at a crankshaft rotational position of approximately 270 degrees; (5) a firing event associated with the second EGR-consuming cylinder 22 located in right bank 26 occurring at a crankshaft rotational position of approximately 360 degrees; (6) a firing event associated with the second EGR-producing cylinder 14 occurring at a crankshaft rotational position of approximately 450 or 480 degrees; (7) a firing event associated with the EGR-consuming cylinder 18 located in left bank 16 occurring at a crankshaft rotational position of approximately 540 degrees; and (8) a firing event associated with the first EGR-producing cylinder 12 occurring at a crankshaft rotational position of approximately 630 degrees.

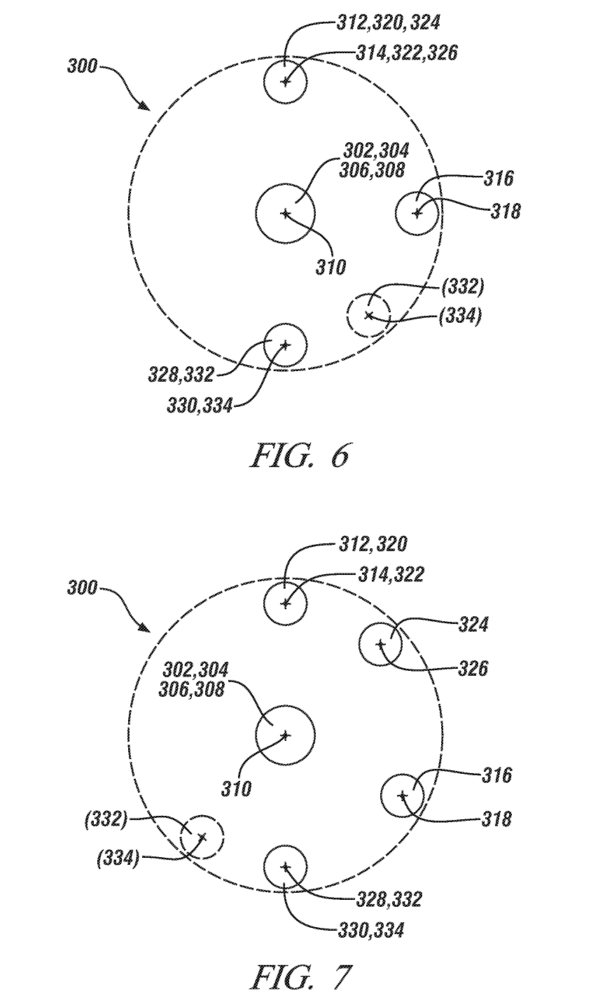

To facilitate such a firing sequence, with an engine block angle 21 of 90 degrees, as shown in FIG. 6, the crankpins 312, 316, 320, 324, 328, and 332 are arranged asymmetrically about the crankshaft axis of rotation as follows: (1) the first crankpin 312 is arranged at a rotational position of approximately 0 degrees; (2) the second crankpin 316 is arranged at a rotational position of approximately 270 degrees; (3) the third crankpin 320 is arranged at a rotational position of approximately 0 degrees; (4) the fourth crankpin 324 is arranged at a rotational position of approximately 0 degrees; (5) the fifth crankpin 328 is arranged at a rotational position of approximately 180 degrees; and (6) the sixth crankpin 332 is arranged at a rotational position of approximately 180 degrees (for a fairly precise even-firing embodiment) or approximately 210 degrees (for a less precise even-firing embodiment).

To facilitate such a firing sequence, with an engine block angle 21 of 60 degrees, as shown in FIG. 7, the crankpins 316, 324, and 332 interacting with the cylinders of the left bank 16 are shifted 30 degrees about the crankshaft axis of rotation. Accordingly, the crankpins the crankpins 312, 316, 320, 324, 328, and 332 are arranged asymmetrically about the crankshaft axis of rotation as follows: (1) the first crankpin 312 is arranged at a rotational position of approximately 0 degrees; (2) the second crankpin 316 is arranged at a rotational position of approximately 240 degrees; (3) the third crankpin 320 is arranged at a rotational position of approximately 0 degrees; (4) the fourth crankpin 324 is arranged at a rotational position of approximately 330 degrees; (5) the fifth crankpin 328 is arranged at a rotational position of approximately 180 degrees; and (6) the sixth crankpin 332 is arranged at a rotational position of approximately 150 degrees (for a fairly precise even-firing embodiment) or approximately 180 degrees (for a less precise even-firing embodiment).

Thus, a “near-even fire” combustion sequence is facilitated, whereby, in the case of a 6-cylinder internal combustion engine, with two cylinders operating on a 2-stroke cycle and four cylinders operating on a four-stroke cycle, eight nearly evenly spaced firing events occur in about 720 degrees of rotation of the crankshaft. The invention has been described above primarily with reference to its application in a 6-cylinder engine. It should be clear to one skilled in the art of internal combustion engines that engines of other cylinder numbers, and varied configurations, can easily be envisaged and that the invention should not, and cannot be limited to those examples provided herein.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. A crankshaft for an internal combustion engine comprising:
at least four main journals aligned on a crankshaft axis of rotation; and
at least six crankpins, each of the at least six crankpins being disposed about a respective crankpin axis and positioned between the at least four main journals;
each of the respective crankpin axes being oriented parallel to, and spaced radially from, the crankshaft axis of rotation;
each of the at least six crankpins being joined to a pair of crank arms for force transmission between each of the at least six crankpins and the respective pair of crank arms;
each crank arm being joined to a respective main journal for transmitting torque between the crank arm and the main journal;
the at least six crankpins being disposed asymmetrically about the crankshaft axis of rotation.

2. A crankshaft for an internal combustion engine as in claim 1, wherein the at least six crankpins comprise at least two crankpins disposed substantially at a first rotational position about the crankshaft axis of rotation.

3. A crankshaft for an internal combustion engine as in claim 2, wherein the at least six crankpins comprise at least three crankpins disposed substantially at a first rotational position about the crankshaft axis of rotation.

4. A crankshaft for an internal combustion engine as in claim 3, wherein a crankpin is disposed substantially at a second rotational position about the crankshaft axis of rotation, and wherein the second rotational position is approximately 180 degrees apart from the first rotational position.

5. A crankshaft for an internal combustion engine as in claim 4, wherein a crankpin is disposed substantially at a third rotational position about the crankshaft axis of rotation, and wherein the third rotational position is approximately 210 degrees apart from the first rotational position.

6. A crankshaft for an internal combustion engine as in claim 5, wherein a crankpin is disposed substantially at a fourth rotational position about the crankshaft axis of rotation, and wherein the fourth rotational position is approximately 270 degrees apart from the first rotational position.

7. A crankshaft for an internal combustion engine as in claim 3, wherein the at least six crankpins comprise a first crankpin, a second crankpin, a third crankpin, a fourth crankpin, a fifth crankpin, and a sixth crankpin arranged sequentially along a crankshaft axis of rotation, and wherein the at least three crankpins comprise the first crankpin, the third crankpin, and the fourth crankpin.

8. A crankshaft for an internal combustion engine as in claim 7, wherein the fifth crankpin is disposed substantially at a second rotational position about the crankshaft axis of rotation, and wherein the second rotational position is approximately 180 degrees apart from the first rotational position.

9. A crankshaft for an internal combustion engine as in claim 7, wherein the sixth crankpin is disposed substantially at a third rotational position about the crankshaft axis of rotation, and wherein the third rotational position is approximately 210 degrees apart from the first rotational position.

10. A crankshaft for an internal combustion engine as in claim 7, wherein the second crankpin is disposed substantially at a fourth rotational position about the crankshaft axis of rotation, and wherein the fourth rotational position is approximately 270 degrees apart from the first rotational position.

11. A crankshaft for an internal combustion engine as in claim 7, wherein the fifth crankpin and the sixth crankpin are disposed substantially at a second rotational position about the crankshaft axis of rotation, and wherein the second rotational position is approximately 180 degrees apart from the first rotational position.

12. A crankshaft for an internal combustion engine as in claim 3, wherein the at least six crankpins comprise a first crankpin, a second crankpin, a third crankpin, a fourth crankpin, a fifth crankpin, and a sixth crankpin arranged sequentially along a crankshaft axis of rotation, and wherein the at least three crankpins comprise the first crankpin, the fourth crankpin, and the fifth crankpin.

13. A crankshaft for an internal combustion engine as in claim 12, wherein the third crankpin is disposed substantially at a second rotational position about the crankshaft axis of rotation, and wherein the second rotational position is approximately 180 degrees apart from the first rotational position.

14. A crankshaft for an internal combustion engine as in claim 12, wherein the second crankpin is disposed substantially at a third rotational position about the crankshaft axis of rotation, and wherein the third rotational position is approximately 210 degrees apart from the first rotational position.

15. A crankshaft for an internal combustion engine as in claim 12, wherein the sixth crankpin is disposed substantially at a fourth rotational position about the crankshaft axis of rotation, and wherein the fourth rotational position is approximately 270 degrees apart from the first rotational position.

16. A crankshaft for an internal combustion engine as in claim 12, wherein the second crankpin and the third crankpin are disposed substantially at a second rotational position about the crankshaft axis of rotation, and wherein the second rotational position is approximately 180 degrees apart from the first rotational position.

17. A crankshaft for an internal combustion engine as in claim 2, wherein the at least six crankpins comprise at least two crankpins disposed substantially at a second rotational position about the crankshaft axis of rotation, and wherein the second rotational position is approximately 180 degrees apart from the first rotational position.

18. A crankshaft for an internal combustion engine as in claim 2, wherein the at least six crankpins comprise at least two crankpins disposed substantially at a second rotational position about the crankshaft axis of rotation, and wherein the second rotational position is approximately 150 degrees apart from the first rotational position.

19. A crankshaft for an internal combustion engine as in claim 2, wherein the at least six crankpins comprise a crankpin disposed substantially at a second rotational position about the crankshaft axis of rotation, wherein the second rotational position is approximately 150 degrees apart from the first rotational position, wherein the at least six crankpins comprise a crankpin disposed substantially at a third rotational position about the crankshaft axis of rotation, wherein the third rotational position is approximately 180 degrees apart from the first rotational position, wherein the at least six crankpins comprise a crankpin disposed substantially at a fourth rotational position about the crankshaft axis of rotation, wherein the fourth rotational position is approximately 240 degrees apart from the first rotational position, wherein the at least six crankpins comprise a crankpin disposed substantially at a fifth rotational position about the crankshaft axis of rotation, wherein the fifth rotational position is approximately 330 degrees apart from the first rotational position.
